(19) United States
(12) Patent Application Publication
(10) Pub. No.: US 2014/0055121 A1
(43) Pub. Date: Feb. 27, 2014

(54) PUMP CONTROL CIRCUIT AND INTEGRATED CIRCUIT INCLUDING THE SAME

(71) Applicant: SK HYNIX INC., Incheon-si (KR)

(72) Inventor: Mi Sun Yoon, Seoul (KR)

(73) Assignee: Sk hynix Inc., Incheon-si (KR)

(21) Appl. No.: 13/719,207

(22) Filed: Dec. 18, 2012

(30) Foreign Application Priority Data
Aug. 24, 2012 (KR) 10-2012-0093106

(51) Int. Cl. G05F 3/02

(52) U.S. Cl. CPC G05F 3/02
USPC 323/318

(57) ABSTRACT

An integrated circuit includes a peripheral circuit, a voltage supplying circuit, and a controller The voltage supplying circuit is configured to select one or more second pumps from the plurality of first pumps in response to a function select signal and generate a corresponding one or more operation voltages to be supplied to the peripheral circuit. The controller is configured to control the peripheral circuit and the voltage supplying circuit in response to an operation command and transmit the function select signal corresponding to the operation command to the voltage supplying circuit.

### CROSS-REFERENCE TO RELATED APPLICATION

This application claims priority from Korean Patent Application No. 10-2012-0093106, filed on Aug. 24, 2012, the contents of which are incorporated herein by reference in its entirety.

### BACKGROUND

The present invention relates to a charge pump control circuit and an integrated circuit including the same.

An integrated circuit such as a semiconductor memory device may be a composite micro electronic device or system where many electronic components may be formed on one substrate or may be combined with the substrate. Many integrated circuits may include a charge pump. A charge pump may convert a first DC voltage to a second DC voltage. A charge pump may allow an integrated circuit to receive only a single DC supply voltage and generate other DC voltages to support different functionalities and/or subcircuits on the integrated circuit.

Accordingly, it would be advantageous to have an improved charge pump control circuit and an integrated circuit including the same.

### SUMMARY OF THE INVENTION

Embodiments of the present invention provide a pump control circuit to independently control initialization operations of one or more charge pumps and independently perform control operations of the one or more charge pumps and an integrated circuit including the pump control circuit and a controller for controlling operation of the integrated circuit.

An integrated circuit according to one embodiment includes a peripheral circuit, a voltage supplying circuit including a plurality of first pumps, and a controller. The voltage supplying circuit is configured to select one or more second pumps from the plurality of first pumps in response to a function select signal and generate a corresponding one or more operation voltages to be supplied to the peripheral circuit. The controller is configured to control the peripheral circuit and the voltage supplying circuit in response to an operation command and transmit the function select signal corresponding to the operation command to the voltage supplying circuit.

The voltage supplying circuit may include a decoder configured to receive the function select signal and output a function signal by decoding the function select signal and an enable signal generating section configured to output one or more enable signals for enabling the corresponding one or more second pumps in response to the function signal.

The controller may be further configured to transmit a pump initialization signal to the voltage supplying circuit and the enable signal generating section may be further configured to output the one or more enable signals when the pump initialization signal is enabled.

The enable signal generating section may include a first logic gate configured to output a pump enable signal based on the function signal and the pump initialization signal and one or more second logic gates configured to output the one or more enable signals based on the pump enable signal and the function signal.

The voltage supplying circuit further includes a function block configured to in response to the function signal output a ready signal when output voltages of the one or more second pumps are higher than corresponding charging voltage levels and output a discharge signal when the output voltages of the one or more second pumps are lower than corresponding discharging voltage levels.

The controller may be further configured to control the peripheral circuit in response to the ready signal so that the peripheral circuit operates by using the one or more operation voltage and control the peripheral circuit in response to the discharge signal so that the peripheral circuit operates without using the one or more operation voltages.

A voltage supplying circuit according to another embodiment includes a plurality of first pumps configured to output one or more operation voltages and a pump control circuit including a decoder configured to output a first function signal selected from a plurality of function signals according to an operation command and an enable signal generating section configured to output one or more enable signals for operating one or more corresponding second pumps selected from the plurality of first pumps in response to the function signal.

A voltage supplying circuit according to yet another embodiment may include a decoder configured to output a first function signal selected from function signals in response to an operation command; and an enable signal generating section configured to output one or more enable signals for operating one or more corresponding second pumps selected from a plurality of first pumps in response to the function signal.

According to some embodiments, a pump control circuit and an integrated circuit including the same separate control operation of peripheral circuits from control operation of a charge pump, and thus they enable operational control of the peripheral circuit while the charge pump is begin initialized and an output voltage of the charge pump reaches a target level. As a result, total operation time of the integrated circuit may reduced.

### BRIEF DESCRIPTION OF THE DRAWINGS

The above and other features and advantages of the present invention will become readily apparent by reference to the following detailed description when considered in conjunction with the accompanying drawings.

FIG. 1 is a block diagram illustrating an integrated circuit according to some embodiments.

FIG. 2 is a view illustrating an integrated circuit according to some embodiments.

FIG. 3 is a view illustrating representative combinations of pumps selected for various operation commands according to some embodiments.

FIG. 4 is a view illustrating a circuit diagram of the pump controller of FIG. 2 according to some embodiments.

FIG. 5a is a view illustrating the function block group of FIG. 2 according to some embodiments.

FIG. 5b is a view illustrating a first function block of FIG. 5a according to some embodiments.

### DETAILED DESCRIPTION

Hereinafter, embodiments of the present invention will be explained in more detail with reference to the accompanying drawings. Although embodiments have been described with reference to a number of illustrative embodiments thereof, it should be understood that numerous other modifications and embodiments can be devised by those skilled in the art that will fall within the spirit and scope of the principles of this disclosure.

Internal components of an integrated circuit may need to be initialized when a supply voltage is supplied to the integrated circuit. In some embodiments, the process includes a step of initializing charge pumps for supplying one or more operation voltages to internal components of the integrated circuit.

Different types of charge pumps having various functions may be included in the integrated circuit. Each of the charge pumps may be initialized based on the desired operation of the integrated circuit. A time required to increase or decrease an output voltage of each of the charge pumps to a target voltage may be different depending on the desired operation of the integrated circuit.

A controller for controlling the operation of the integrated circuit may generate control signals for controlling each of the charge pumps. A number of the control signals for controlling the charge pump may increase as the integrated circuit becomes more complex. Accordingly, a time required to generate the control signals provided to each of the charge pumps may get longer. As a result, generating other control signals for controlling a peripheral circuit in the integrated circuit may be delayed. Consequently, a total operation time of the integrated circuit may increase undesirably.

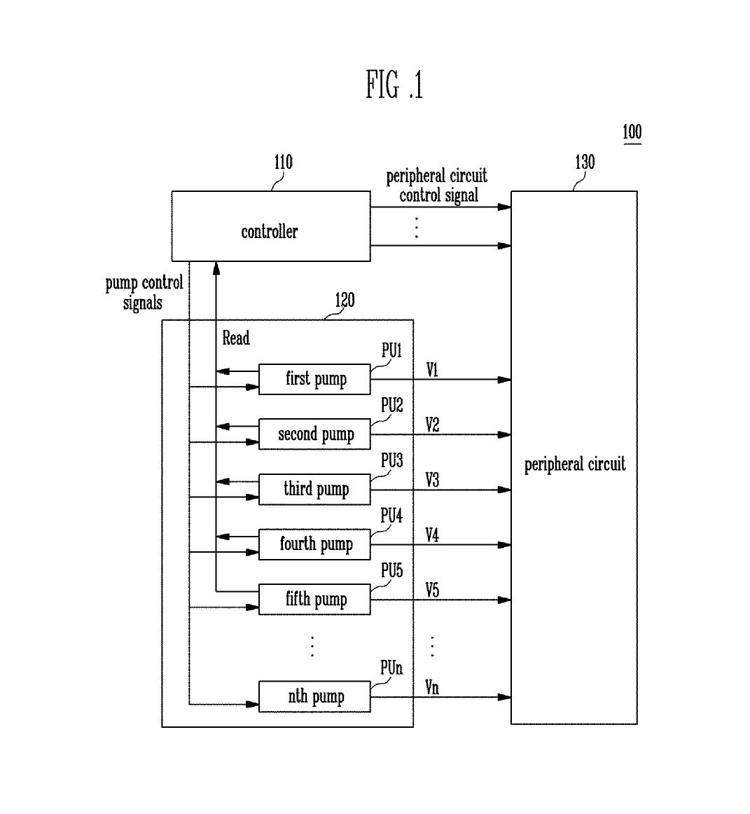

FIG. 1 is a block diagram illustrating an integrated circuit 100 according to some embodiments.

As shown in FIG. 1, one or more circuits may be included in the integrated circuit 100. A structure and configuration of the integrated circuit 100 may vary according to a type of the integrated circuit 100. In some examples, when the integrated circuit 100 is a semiconductor memory device, it may include a memory cell array, a page buffer circuit, etc.

Where internal elements in the integrated circuit 100 are defined as a peripheral circuit 130, the integrated circuit 100 may include a voltage supplying circuit 120 for generating operation voltages for the peripheral circuit 130 and a controller 110 for generating signals to control operation of the voltage supplying circuit 120.

The voltage supplying circuit 120 may include first to nth charge pumps or pumps PU1-PUn for generating operation voltages V1-Vn, respectively. The first to the nth pumps PU1-PUn may output the operation voltages V1-Vn in response to pump control signals output from the controller 110.

The operation voltages V1-Vn of the integrated circuit 100 may vary according to an operation command and/or function. In some embodiments, the controller 110 may select a pump from the pumps PU1-PUn corresponding to each of the functions and may further control an initialization operation using the selected pump.

In some examples, when the first through third voltages V1-V3 may be needed for a program command, the controller 110 may transmit the pump control signals to the voltage supplying circuit 120 to operate the first through third pumps PU1-PU3.

In some examples, the first through third pumps PU1-PU3 in the voltage supplying circuit 120 may start the initialization operation in response to the pump control signals and further start corresponding charge pumping operations. When the first through third pumps PU1-PU3 start their respective charge pumping operations, output voltages of the first through third pumps PU1-PU3 may reach the voltages V1-V3 after a certain period of time has elapsed.

Each of the pumps PU1-PUn may transmit a Ready signal to the controller 110 when corresponding output voltages V1-Vn reach desired voltage levels. The Ready signal may include information indicating that the output voltage has reached the desired level.

In some embodiments, the controller 110 may not yet be able to control the peripheral circuit 130, but may merely stand by until the Ready signal is received from each of the pumps from which an operation voltage is required. In some embodiments, the controller 110 may simultaneously control the voltage supplying circuit 120 and the peripheral circuit 130. A delay necessary to wait on the pumps PU1-PUn and the voltage supplying circuit 120 may increase a time required to complete a program operation.

Accordingly, some embodiments provide an integrated circuit for independently controlling a peripheral circuit and a voltage supplying circuit.

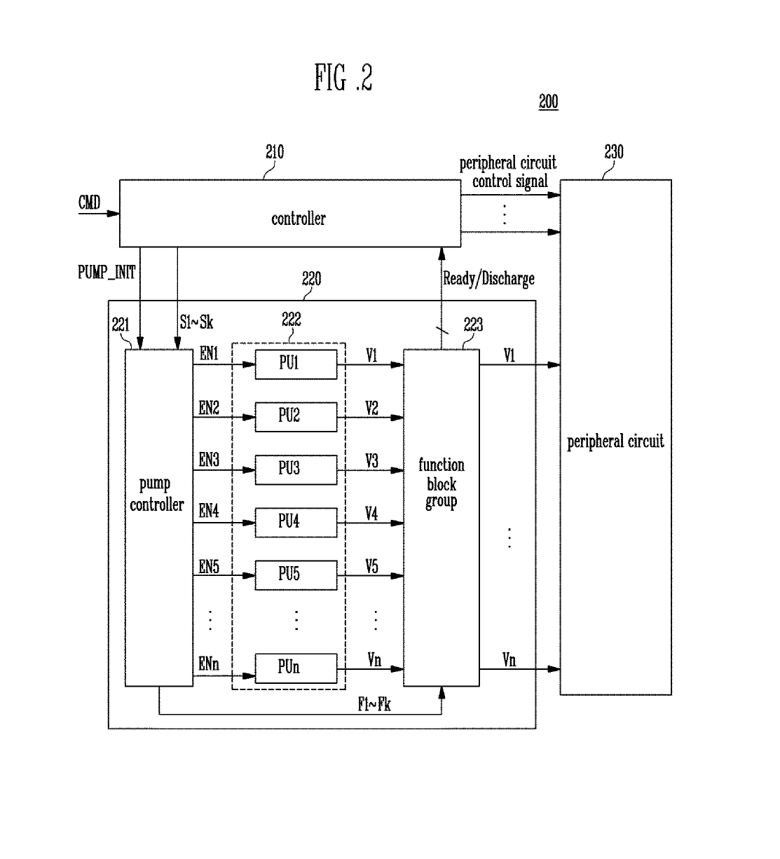

FIG. 2 is a view illustrating an integrated circuit 200 according to some embodiments.

As shown in FIG. 2, the integrated circuit 200 may include a controller 210 for controlling a peripheral circuit 230 and a voltage supplying circuit 220 for supplying operation voltages to the peripheral circuit 230.

The peripheral circuit 230 may include one or more circuits, and a type of the circuits included in the peripheral circuit 230 may vary according to a type of the integrated circuit 200.

In some examples, where the integrated circuit 200 is a memory device, the peripheral circuit 230 may include a memory cell array, a page buffer circuit, etc.

The controller 210 may output peripheral circuit control signals for controlling operation of the peripheral circuit 230 according to an operation command CMD. The controller 210 may outputs first to kth function select signals S1-Sk and a pump initialization signal PUMP_INIT to generate the operation voltages based on the operation command CMD. The function select signals S1-Sk and the pump initialization signal PUMP_INIT may be provided to the voltage supplying circuit 220.

In some embodiments, k operation commands CMD may be received by the controller 210. The controller 210 may control operation of the peripheral circuit 230 according to first to kth functions corresponding to each of the operation commands CMD and output a corresponding one of the function select signals S1-Sk with a high level.

The first to the kth functions may be a set of algorithms and/or instructions for executing the operation commands CMD. In some examples, a first function corresponding to a program command may be a set of instructions for performing a program operation, and a second function corresponding to a read command may be a set of instructions for performing a read operation.

In some examples, when the program command is received, the controller 210 may control operation of the peripheral circuit 230 using the first function by outputting the first function select signal S1 with a high level. When the read command is received, the controller 210 may control operation of the peripheral circuit 230 using the second function by outputting the second function select signal S2 with a high level.

In some embodiments, the controller 210 has access to information associated with the first to the kth functions corresponding to the operation commands and information concerning the function select signals S1-Sk. The information may be stored in a storage device (not shown) in the controller 210 or may be stored in one or more external storage devices.

The voltage supplying circuit 220 may generate operation voltages in response to the function select signals S1-Sk and the pump initialization signal PUMP_INIT from the controller 210 and supply the generated operation voltages.

The voltage supplying circuit 220 may include a pump controller 221, a pump group 222, and a function block group 223.

The pump controller 221 may output first to nth enable signals EN1 to ENn for controlling the pump group 222 in response to the function select signals S1-Sk and the pump initialization signal PUMP_INIT provided by the controller 210. In addition, the pump controller 221 may output first to kth function signals F1-Fk corresponding to the first to the kth function select signals S1-Sk to control the function block group 223. A relationship between the function select signals S1-Sk and the function signals F1-Fk will be described in further detail below.

The pump group 222 may include first to nth charge pumps or pumps PU1 to PUn. The first to the nth pumps PU1-PUn may start an initialization operation in response to the first to the nth enable signals EN1-ENn, respectively. The first to the nth pumps PU1-PUn may output first to nth voltages V1-Vn, respectively.

The function block group 223 may include first to kth function blocks FB1-FBk operating in response to the first to the kth function signals F1-Fk received from the pump controller 221. The function block group 223 will be described in further detail below.

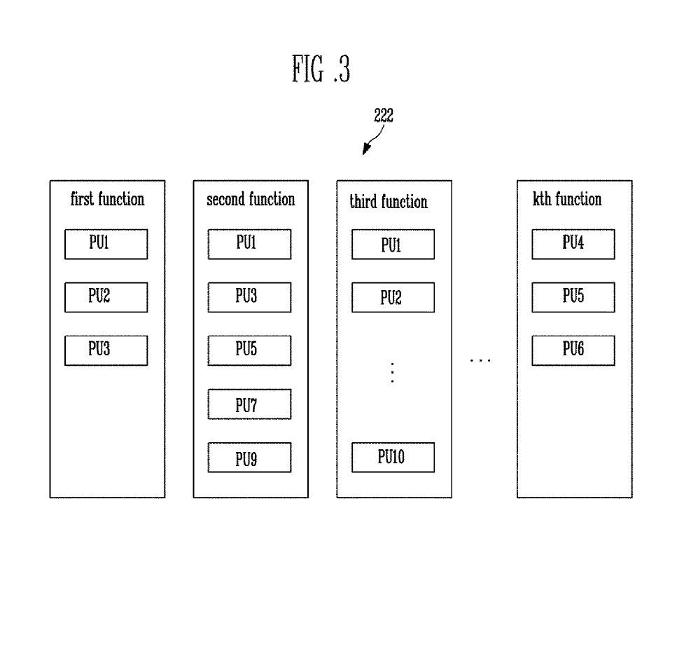

According to some embodiments, the pumps selected when the operation command CMD corresponds to each of the first to the kth functions are shown in FIG. 3.

FIG. 3 is a view illustrating representative combinations of pumps selected for various operation commands CMD corresponding to the first to the kth functions according to some embodiments.

The controller 210 may control the operation of the peripheral circuit 230 based on the first to the kth functions. Combinations of the operation voltages may vary based on the first to kth the functions.

As shown in the examples of FIG. 3, the pumps PU1-PU3 may operate when the operation command CMD corresponds to the first function. The pumps PU1, PU3, PU5, PU7 and PU9 may operate when the operation command CMD corresponds to the second function.

Additionally, the pumps PU1-PU10 may operate when the operation command CMD corresponds to a third function. The pumps PU4-PU6 may operate when the operation command CMD corresponds to the kth function.

The pump controller 221 should selectively generate subsets of the first to the nth enable signals EN1-ENn that correspond to the pumps that are to be operated when the operation command CMD corresponds to each of the first to the kth functions.

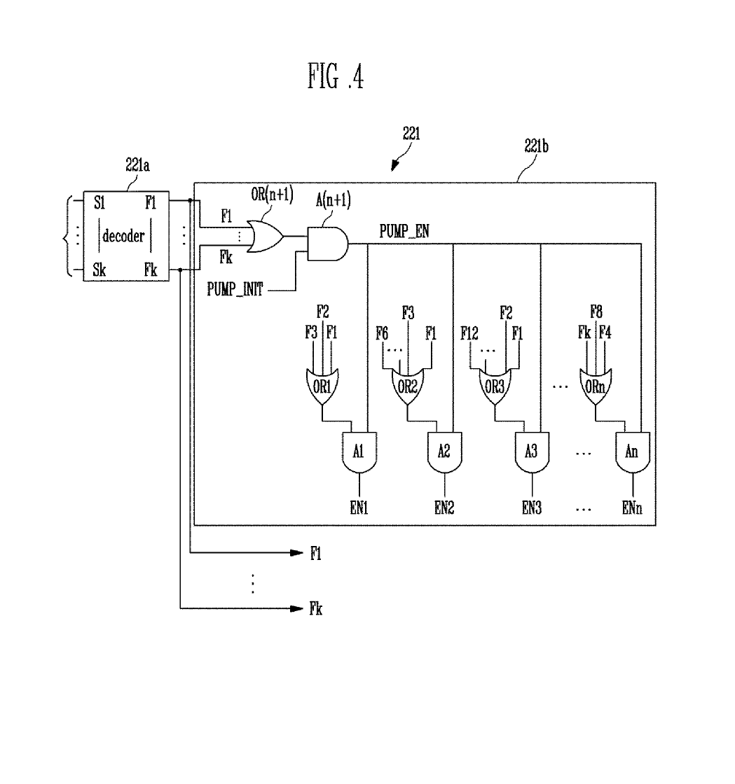

FIG. 4 is a view illustrating a circuit diagram of the pump controller 221 of FIG. 2 according to some embodiments.

As shown in FIG. 4, the pump controller 221 may include a decoder 221a and an enable signal generating section 221b.

The decoder 221a may generate the function signals F1-Fk in response to the function select signals S1-Sk received from the controller 210. In some embodiments, the function signals F1-Fk correspond to the function select signals S1-Sk, respectively. According to some embodiments, other relationships between the function signals F1-Fk and the function select signals S1-Sk are possible. In some examples, the decoder 221a may output the function signals F1-Fk in response to the function select signals, whose number being smaller than k, so as to reduce the number of function select signals output from the controller 210.

The enable signal generating section 221b may selectively generate the enable signals EN1-ENn based on the function signals F1-Fk and the pump initialization signal PUMP_INIT.

The enable signal generating section 221b may include first to (n+1)st OR gates OR1 to OR(n+1) and first to (n+1)st AND gates A1 to A(n+1).

The (n+1)st OR gate OR(n+1) may perform an OR operation on the function signals F1-Fk. An output of the (n+1)st OR gate OR(n+1) may be provided to the (n+1)st AND gate A(n+1).

The (n+1)st AND gate A(n+1) may perform an AND operation on the output of the (n+1)st OR gate OR(n+1) and the pump initialization signal PUMP_INIT. An output of the (n+1)st AND gate A(n+1) may be a pump enable signal PUMP_EN.

The first to the nth OR gates OR1-ORn may generate select signals for controlling operation of each of the pumps PU1-PUn, respectively. The OR gates OR1-ORn may generate the select signals for selecting each pump to be enabled from the pumps PU1-PUn based on the function signals F1-Fk.

Operation of the OR gates OR1 to ORn will now be described with reference to the embodiments of FIG. 3 and FIG. 4.

As shown in the embodiments of FIG. 3, the first pump PU1 may operate when the operation command CMD corresponds to the first function, the second function, and the third function.

Accordingly, the first pump PU1 should be enabled when the first, second, and third function signals are generated.

As shown in the embodiments of FIG. 4, the function signals for enabling the first pump PU1, e.g. the first, second, and third function signals F1, F2, and F3 may be provided as inputs to the first OR gate OR1.

The first OR gate OR1 may perform an OR operation on the function signals F1, F2, and F3, thereby generating a select signal corresponding to pump PU1. The OR operation of OR1 may output a high level when one or more of the function signals F1, F2, or F3 has a high level. That is, in the event that any one of the first, second, or third function signals F1, F2, or F3 has a high level, the first OR gate OR1 may generate the select signal for pump PU1 with a high level.

The second pump PU2 operates when the operation command CMD corresponds to the first function, the third function, and the sixth function. The second OR gate OR2 may receive the first function signal F1, the third function signal F3, and the sixth function signal F6. In the event that any one of first, third, or sixth function signals has a high level, the second OR gate OR2 may generate a select signal for pump PU2 with a high level.

Similarly, each of the third to the nth OR gates OR3-ORn may receive corresponding function signals and perform an OR operation on the received function signals, thereby generating a select signal for the corresponding pump PU3-PUn.

Each of the first to the nth AND gates A1-An may perform an AND operation on the corresponding pump select signal received from a corresponding one of the OR gates OR1-ORn and the pump enable signal PUMP_EN. The AND operation may output a high level only when the pump enable signal PUMP_EN and the corresponding pump select signal have a high level.

In some embodiments, when the pump enable signal PUMP_EN has a high level and the corresponding OR gate for the corresponding pump select signal, both have a high level, the enable signal for the corresponding pump will have a high level.

In the embodiments of FIGS. 3 and 4, when the first function signal F1 has a high level, the first, second, and third OR gates OR1, OR2, and OR3 may generate the pump select signals for pumps PU1, PU2, and PU3 with a high level.

Additionally, the first, second, and third AND gates A1-A3 may generate a high level for the enable signals EN1-EN3 because both the corresponding pump select signals and the pump enable signal PUMP_EN each have a high level.

As a result, in the embodiments of FIGS. 3 and 4, the first, second, and third pumps PU1, PU2, and PU3 may be enabled. In some embodiments, once enabled, pumps PU1, PU2, and PU3 may perform an initialization operation and start the pumping operation. That is, when the first function signal F1 has a high level, the first, second, and third pumps PU1, PU2, and PU3 may start to operate, thereby generating a first, second, and third voltages V1, V2, and V3.

A time required for reaching a target level after the pumping operation is started may differ for each of the pumps that are enabled. According to some embodiments, when all of the enabled pumps as selected by the function signals F1-Fk reach their desired operation voltage, a Ready signal may be transmitted to controller 210.

The controller 210 may control an initialization operation of the peripheral circuit 230 while the voltage supplying circuit 220 generates the operation voltages. The voltage supplying circuit 220 may supply the operation voltages to the peripheral circuit 230 after the peripheral circuit 230 completes the initialization operation. In some embodiments, the controller 210 may verify whether the voltage supplying circuit 220 can supply desired operation voltages to the peripheral circuit 230.

The function block group 223 may verify whether every one of the selected pumps has reached its desired operation voltage. The function block group may generate the ready signal Ready based on the verifying result. In some embodiments, the function block group 223 may operate in the same manner as the above method when outputs of selected pumps are discharged. The function block group 223 may verify whether every one of the selected pumps has discharged to a voltage less than a preset voltage. The function block group 223 may output a discharge verify signal Discharge based on the verifying result.

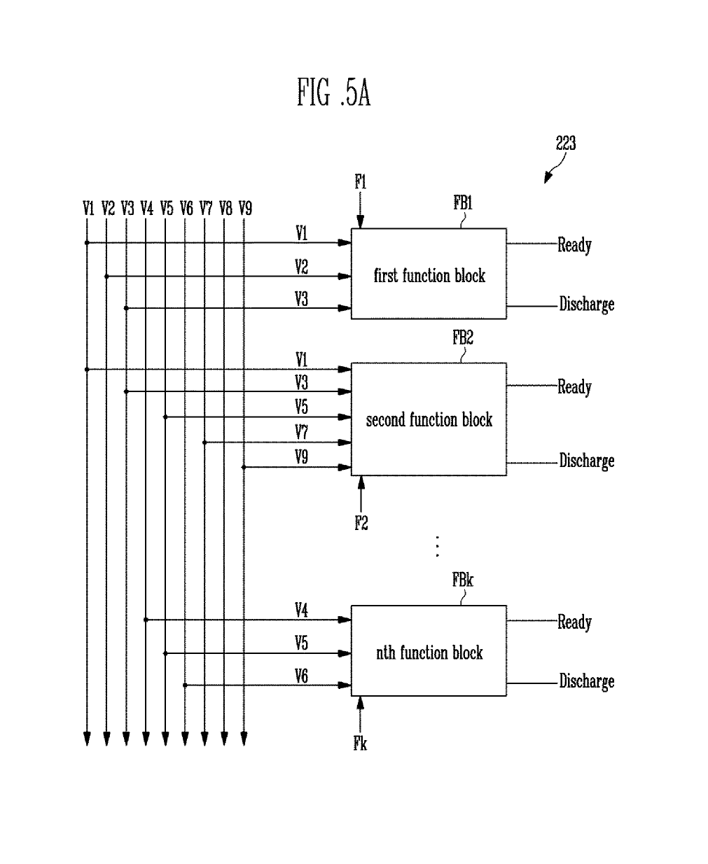

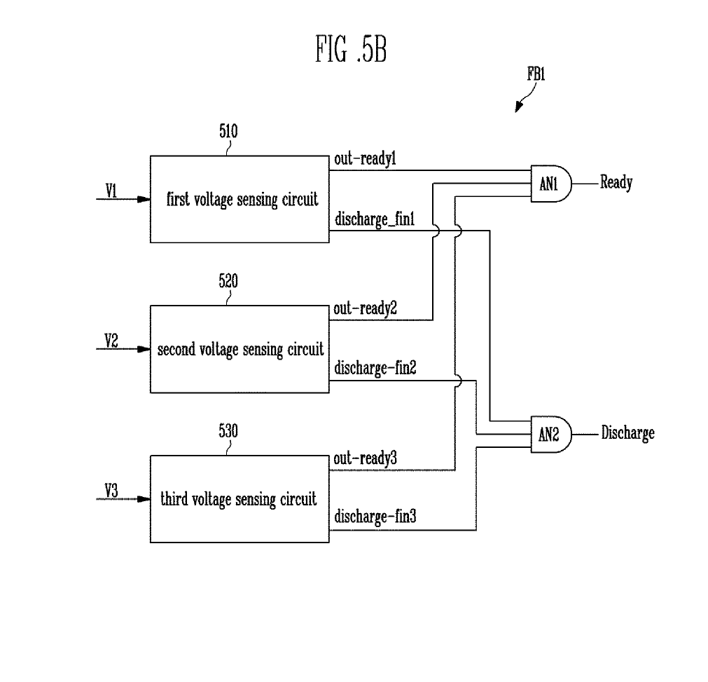

FIG. 5a is a view illustrating the function block group 223 of FIG. 2, and FIG. 5b is a view illustrating a first function block FB1 of FIG. 5a according to some embodiments.

As shown in FIG. 5a, the function block group 223 may include first to kth function blocks FB1-FBk. Function blocks FB1-FBk may operate in response to corresponding function signals F1-Fk.

Each of the function blocks FB1-FBk may include a voltage sensing circuit for receiving one or more of the outputs V1-Vn of the pumps PU1-PUn and verifying the voltage level of the respective outputs V1-Vn.

As shown in the embodiments of FIG. 5b, the first function block FB1 may include a first, second, and third voltage sensing circuits 510, 520, and 530, respectively.

The first function block FB1 may include the voltage sensing circuits 510-530 for receiving the first, second, and third voltages V1, V2, and V3, respectively, generated by the first, second, and third pumps PU1, PU2, and PU3 and sense the voltage level of the first, second, and third voltages V1, V2, and V3.

When the pumping operation is performed, the first, second, and third voltage sensing circuits 510, 520, and 530 may sense whether the level of the first, second, and third voltages V1, V2, and V3 have respectively increased to voltage levels higher than charging target voltage levels and output the output ready signal Ready based on the charge sensing result. When the discharge operation is performed, the first, second, and third voltage sensing circuits 510, 520, and 530 may sense whether the first, second, and third voltages V1, V2, and V3 have respectively discharged to voltage levels less than discharging target levels and output a discharge completion signal Discharge based on the discharge sensing result.

When the pumping operation starts, the first voltage sensing circuit 510 may sense whether the first voltage V1 increases to a first voltage level higher than a first charging target voltage level and output an output ready signal out_ready1 based on the charge sensing result.

The first voltage sensing circuit 510 may sense whether the first voltage V1 is discharged to a voltage level less than a first discharging target voltage level when the pumping operation is stopped and output a discharge completion signal discharge_fin1 based on the discharge sensing result.

An AND gate AN1 may perform an AND operation on the output ready signals out_ready1, out_ready2, and out_ready3 generated by the first, second, and third voltage sensing circuits 510, 520, and 530, respectively, and generate the ready signal Ready based on the AND operation.

An AND gate AN2 may perform an AND operation on the discharge completion signals discharge_fin1, discharge_fin2, and discharge_fin3 generated by the first, second, and third voltage sensing circuits 510, 520, and 530 and generate the discharge signal Discharge based on the OR operation.

The ready signal Ready and the discharge signal Discharge may be delivered to the controller 210. The controller 210 may detect whether the operation voltages are prepared or discharging is completed based on the ready signal Ready or the discharge signal Discharge, respectively.

Referring back to FIG. 2, the integrated circuit 200 may be a memory device. The controller 210 may control operation of the peripheral circuit 230 based on the first function to perform the program operation. The controller 210 may generate the pump initialization signal PUMP_INIT and the select signals S1-Sk based on the first function and transmit the generated signals PUMP_INIT and S1-Sk to the voltage supplying circuit 220.

In some embodiments, the pump controller 221 of the voltage supplying circuit 220 may output the first function signal F1 and the enable signals EN1-EN3 in response to the pump initialization signal PUMP_INIT and the select signals S1-Sk.

In some embodiments, the pumps PU1-PU3 may perform the initialization operation in response to the enable signals EN1-EN3, respectively and start the pumping operation.

The first function block FB1 may be enabled in response to the first function signal F1, and the third voltage sensing circuits 510, 520, and 530 may sense whether the voltages V1-V3 have each reached a corresponding charging target voltage levels.

The first function block FB1 may output the ready signal Ready when each of the voltages V1-V3 reaches the corresponding charging target voltage levels.

The controller 210 may output the peripheral circuit control signals based on the first function so that the initialization operation of the peripheral circuit 230 and an input operation of data to be programmed, etc. may be performed for the program operation.

The controller 210 may verify whether the ready signal Ready is generated by the voltage supplying circuit 220 before the operation voltages for the program operation are supplied to the peripheral circuit 230. In some embodiments, when the ready signal Ready is not generated, the controller 210 may stop and/or place the operation of the peripheral circuit 230 into stand by until the ready signal Ready is received.

In some embodiments, when the ready signal Ready is received, the controller 210 may output the peripheral circuit control signals based on the operation voltages so that the peripheral circuit 230 may perform the program operation.

In some embodiments, the controller 210 may wait for the discharge signal Discharge from the voltage supplying circuit 220 before it finishes the program operation and finish the program operation when the discharge signal Discharge is received.

In some embodiments, the controller 210 may control the peripheral circuit 230 after it transmits the pump initialization signal PUMP_INIT and the select signals S1-Sk to the voltage supplying circuit 220, but before the operation voltages are used in the peripheral circuit 230.

In some embodiments, when the peripheral circuit 230 is ready to operate, the controller 210 may control the peripheral circuit 230 to use the operation voltages which are supplied by the voltage supplying circuit 220. In some embodiments, the controller 210 may wait until the ready signal Ready is transmitted from the voltage supplying circuit 220 before the operation voltages are used by the peripheral circuit 230. In some embodiments, when the ready signal Ready is received by the controller 210, the controller 210 may control the peripheral circuit 230 to use the operation voltages, thereby performing the other steps in the program operation.

In some embodiments, the controller 210 may wait until the discharge signal Discharge is transmitted by the voltage supplying circuit 220 when the program operation is finished, and finish the program operation when the discharge signal Discharge is received, and then stand by for next command.

In some embodiments, the controller 210 may provide only the pump initialization signal PUMP_INIT and the select signals S1-Sk to the voltage supplying circuit 220. In some embodiments, the controller 210 may efficiently control the peripheral circuit 230. In some embodiments, an operation time of the integrated circuit 200 may be reduced.

Although embodiments have been described with reference to a number of illustrative embodiments thereof, it should be understood that numerous other modifications and embodiments can be devised by those skilled in the art that will fall within the spirit and scope of the principles of this disclosure.

What is claimed is:

1. An integrated circuit comprising:
a peripheral circuit;
a voltage supplying circuit including a plurality of first pumps; and
a controller configured to control the peripheral circuit and the voltage supplying circuit in response to an operation command and transmit a function select signal corresponding to the operation command to the voltage supplying circuit,
wherein the voltage supplying circuit is configured to select one or more second pumps from the plurality of first pumps in response to the function select signal and generate a corresponding one or more operation voltages to be supplied to the peripheral circuit.

2. The integrated circuit of claim 1 wherein the voltage supplying circuit includes:
a decoder configured to receive the function select signal and output a function signal by decoding the function select signal; and
an enable signal generating section configured to output one or more enable signals for enabling the corresponding one or more second pumps in response to the function signal.

3. The integrated circuit of claim 2 wherein:
the controller is further configured to transmit a pump initialization signal to the voltage supplying circuit; and
the enable signal generating section is further configured to output the one or more enable signals when the pump initialization signal is enabled.

4. The integrated circuit of claim 3 wherein the enable signal generating section includes:
a first logic gate configured to output a pump enable signal based on the function signal and the pump initialization signal; and
one or more second logic gates configured to output the one or more enable signals based on the pump enable signal and the function signal.

5. The integrated circuit of claim 2 wherein the voltage supplying circuit further includes a function block configured to in response to the function signal:
output a ready signal when output voltages of the one or more second pumps are higher than corresponding charging voltage levels; and
output a discharge signal when the output voltages of the one or more second pumps are lower than corresponding discharging voltage levels.

6. The integrated circuit of claim 5 wherein the controller is further configured to:
control the peripheral circuit in response to the ready signal so that the peripheral circuit operates by using the one or more operation voltages; and
control the peripheral circuit in response to the discharge signal so that the peripheral circuit operates without using the one or more operation voltages.

7. A voltage supplying circuit comprising:
a plurality of first pumps configured to output one or more operation voltages; and
a pump control circuit including a decoder configured to output a first function signal selected from a plurality of function signals according to an operation command and an enable signal generating section configured to output one or more enable signals for operating one or more corresponding second pumps selected from the plurality of first pumps in response to the function signal.

8. The voltage supplying circuit of claim 7, further comprising:
function blocks, enabled in response to each of the function signals, and configured to:
output a ready signal when output voltages of the one or more second pumps are higher than corresponding charging voltage levels; and
output a discharge signal when the output voltages of the one or more second pumps are lower than corresponding discharging voltage levels.

9. The voltage supplying circuit of claim 7 wherein the enable signal generating section includes:
a first logic gate configured to output a pump enable signal based on the function signal and a pump initialization signal; and
one or more second logic gates configured to output the one or more enable signals corresponding to each of the one or more second pumps based on the function signal and the pump enable signal, so as to enable the corresponding one of the one or more second pumps.

10. A voltage supplying circuit comprising:
a decoder configured to output a first function signal selected from function signals in response to an operation command; and
an enable signal generating section configured to output one or more enable signals for operating one or more corresponding second pumps selected from a plurality of first pumps in response to the function signal.

11. The voltage supplying circuit of claim 10, further comprising:
function blocks, enabled in response to each of the function signals, and configured to:
output a ready signal when output voltages of the one or more second pumps are higher than corresponding charging voltage levels; and
output a discharge signal when the output voltages of the one or more second pumps are lower than corresponding discharging voltage levels.

12. The voltage supplying circuit of claim 10, wherein the enable signal generating section includes:
a first logic gate configured to output a pump enable signal based on the function signal and a pump initialization signal; and
one or more second logic gates configured to output the one or more enable signals corresponding to each of the one or more second pumps based on the selected function signal and the pump enable signal, so as to enable the corresponding one or more second pumps.
